(19) United States
(12) Patent Application Publication
(10) Pub. No.: US 2013/0189062 A1
(43) Pub. Date: Jul. 25, 2013

(54) HYDRAULIC PUMP CONTROL SYSTEM FOR LIFT GATE APPLICATIONS

(71) Applicants: Paul Bark, Canyon Lakes, CA (US); Karapel Ablabutyan, Glendale, CA (US); Luis Arturo Villesscusa, Mexicall, CA (US)

(72) Inventors: Paul Bark, Canyon Lakes, CA (US); Karapel Ablabutyan, Glendale, CA (US); Luis Arturo Villesscusa, Mexicall, CA (US)

(21) Appl. No.: 13/356,115

(22) Filed: Jan. 23, 2012

(51) Int. Cl. B60P 1/44

(52) U.S. Cl. 414/557

(57) ABSTRACT

The hydraulic pump control system enables the synchronization of two independently mounted hydraulic lifting cylinders in a lift gate environment. A directional valve is added to the hydraulic line path between the lift cylinders and their respective pumps and reservoir tank. By connecting two pumps to one motor, the synchronization of the pumps is enabled for power up operations of the lift, and through the additional application of the directional valves, the oil flow rate to the lift cylinders (e.g., during a power down operation) can be maintained as hydraulically identical, thus synchronizing the movement of each lift cylinder with respect to the other, even in the presence other outside conditions that would could otherwise cause a desynchronization of the lift cylinders.

### BACKGROUND

1. Field of the Invention

The present principles relate to lift gates for vehicles. More particularly, it relates a hydraulic pump control for synchronizing at least two hydraulic cylinders in a lift gate environment.

2. Discussion of Related Art

The use of hydraulic cylinders for purposes of lift gate applications is well known in the art. The loading and unloading of lift gate platforms often is performed very quickly, and as a result very often generally up with an unevenly distributed loads being lifted or lowered by the lift gate system.

A common requirement for vehicle lift gate applications is the synchronizing of the hydraulic cylinders to provide a uniform/even lifting and lowering motion of the lift gate platform. As will be appreciated by those of skill in the art, there are many factors that contribute to an uneven lifting of the platform, not the least of which can include unevenly distributed loads on the platform.

Heretofore, there have been mechanical methods that are used to synchronize two or more hydraulic lift cylinders in an effort to maintain an even lift platform through all aspects of lifting, lowering and storing. Some of these mechanical methods include connector or synchronization rods or bars that connect the left side linkage to a right side linkage so the same are substantially forced into synchronization. This method however, has its own problems which those of ordinary skill can appreciate. For example, if the actuating hydraulic cylinders are not in sync with each other, the connecting rod, and/or either of the left or right linkages may be compromised and/or damaged if the load is unevenly distributed on the platform.

Other methods of synchronizing include electrical methods which include sensors for detecting positions of the cylinders in relation to motors, with computer control and corresponding software, etc. These type of mechanical and/or electrical systems are more costly to implement and maintain.

These and other shortfalls of the prior art are addressed by hydraulic pump control system of the present invention.

### SUMMARY

As those of skill in the art will appreciate, synchronizing the lift cylinders with respect to each other requires careful and accurate control of the flow of hydraulic oil in the system and particularly in the lines leading to each lift cylinder.

According to an implementation, the present invention provides hydraulic pump control system that enables the accurate control of the flow of the oil in the system.

According to one embodiment, the hydraulic control system for synchronizing at least two independent hydraulic lift cylinders in a lift gate system includes a motor, a first hydraulic pump and a second hydraulic pump identical to the first hydraulic pump, each hydraulic pump connected to a same single shaft of the motor.

According to another embodiment, the hydraulic control system for synchronizing at least two independent hydraulic lift cylinders in a lift gate system includes: a motor; a first hydraulic pump and a second hydraulic pump identical to the first hydraulic pump, each hydraulic pump connected to a same single shaft of the motor; the first and second hydraulic pumps having a input connected to a reservoir tank, and an output; a first directional valve having a first connection line connecting the first directional valve to the output of the first hydraulic pump, a second connection line connecting the first directional valve to a first lift cylinder, and a third connection line connecting the first directional valve to the reservoir tank; and a second directional valve having a first connection line connecting the second directional valve to the output of the second hydraulic pump, a second connecting line connecting the second directional valve to a second lift cylinder, and a third connection line connecting the first directional valve to the reservoir tank. The first and second directional valves have an open and a closed operable position, and are both biased in the closed position. The open position connects the first hydraulic pump to the first lift cylinder and the second hydraulic pump to the second lift cylinder. The closed position connects the first and second lift cylinders to the reservoir tank.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1a is a perspective view of an exemplary lift gate system to which the present invention may be applied;

FIG. 1b is a perspective view of another exemplary lift gate system to which the

FIG. 2 is a hydraulic schematic diagram of the hydraulic pump control system according to an embodiment of the invention;

FIG. 3a is a hydraulic schematic diagram of the hydraulic pump control system according to a further embodiment of the invention;

FIG. 3b is an enlarged view of the hydraulic control system shown in FIG. 3a, according to an embodiment of the invention; and

FIG. 4 is an electric schematic diagram of the hydraulic pump control system according to an embodiment of the invention.

### DETAILED DESCRIPTION

The present principles are directed to lift gate systems for vehicles, and more specifically to a hydraulic control system for synchronizing two or more hydraulic cylinders supporting a platform in a lift gate system

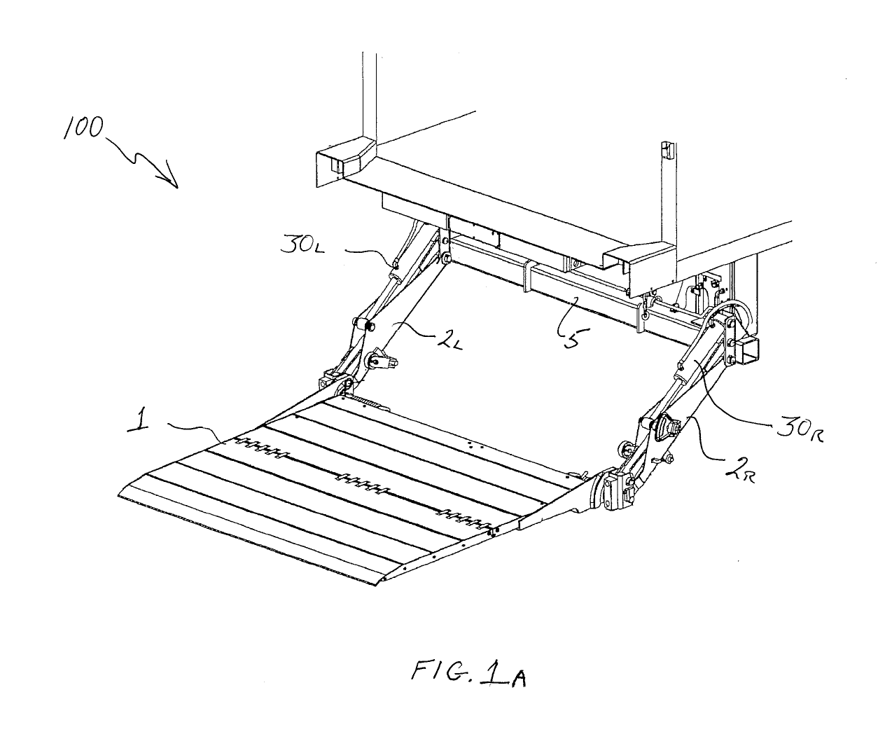

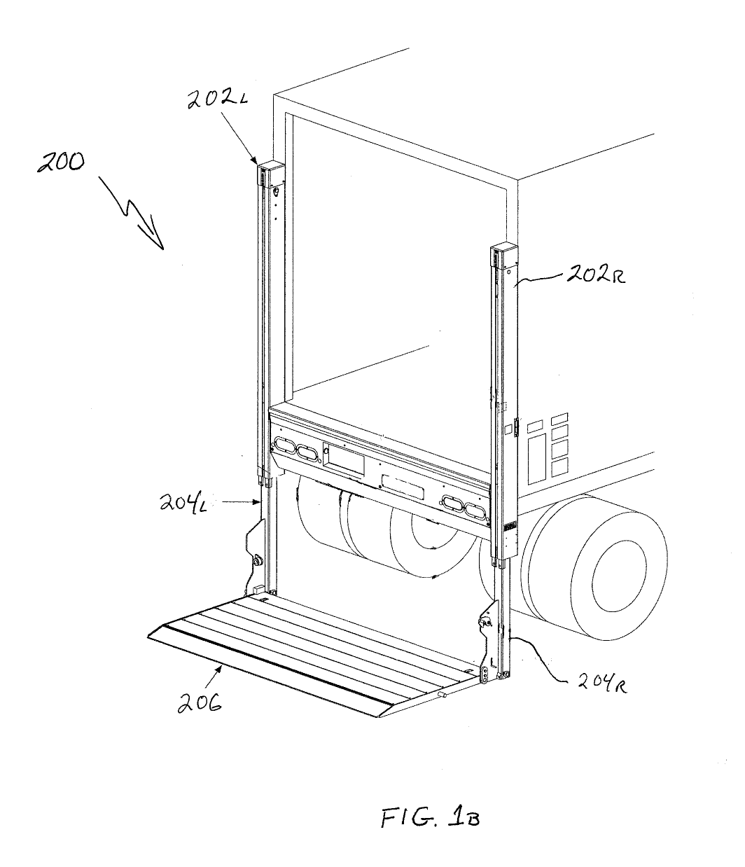

FIG. 1 shows an example of a lift gate system 100 connected to the back of a vehicle/truck. As shown, the lift gate system includes a platform 1, which is connected to at least two opposing arms 2L and 2R, and which arms are connected to main frame 5 mounted to the underside of the vehicle bed. Arms 2L and 2R each have their own hydraulic lifting cylinders 30L and 30R, respectively.

As will be appreciated by this Figure, each of the arms 2L and 2R in this system are independent of each other and do not include a synchronizing bar or other mechanical means by which the motion of one arm is made relative to the other. In other words, each lift arm 2L and 2R is completely independent of the other.

FIG. 1b shows another lift gate system 200 to which the present invention may be implemented. This type of system comprises columns 202 and runners 204 slidably and/or telescopically disposed within the columns 202. With the columns 202 are the hydraulic lift cylinders having a fixed connection toward the top of the column 202 and being internally connected to it corresponding runner 204. The platform is 206 is connected to each runner 204.

As mentioned above, any attempts to move the platform 1 (FIG. 1a), 206 (FIG. 1b) when there is some uneven distribution of the load on the same could result in the movement of the two arms 2L and 2R (FIG. 1a) or runners 204 (FIG. 1b) not being synchronized with each other, and, and thereby could cause serious damage to the lift gate system, not to mention possible damage to the load being moved by the platform.

More specifically, the present invention recognizes that in order to synchronize the lift cylinders, the flow of hydraulic oil to each of the respective lift cylinders must be controlled and the same in both working directions of the lift. Thus, the hydraulic pump control of the present invention provides a mechanism by which the flow of the oil in the system is controlled to maintain synchronization of the lift cylinders. This is because the synchronizing of the cylinders, particularly in the down direction (up position to ground), requires equal oil flow at the respective cylinders, especially in the presence of an unevenly distributed load on the platform. When operating in the up direction (i.e., ground to up position of platform), proper synchronization of pumps feeding oil to each lift cylinder is required.

Those of skill in the art will appreciate that proper synchronization of the pumps in addition to the regulation of the flow of oil in the respective systems connecting the pumps to each lift cylinder will substantially eliminate and address synchronization concerns resulting from various other outside factors affecting the operation of the lift gate system.

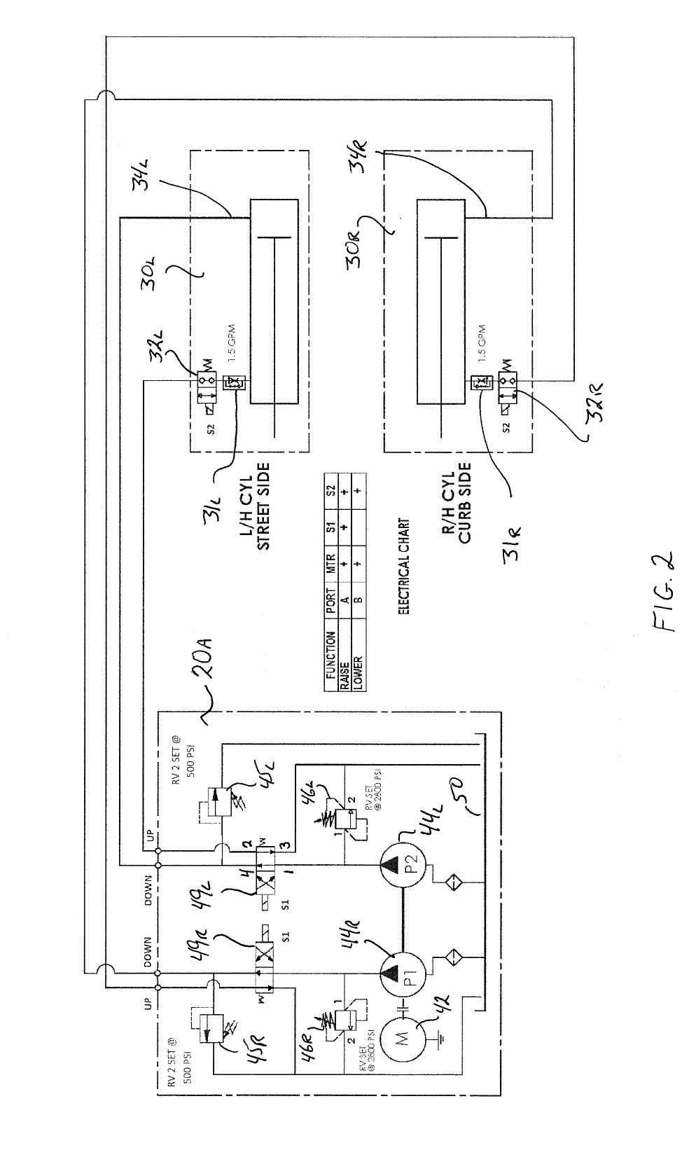

The present invention addresses this synchronization problem of two independently operating hydraulic cylinders by controlling the pumps during an up operation and controlling flow of oil into and out of the respective lift arms during a down operation by providing a hydraulic pump control system 20a shown in FIG. 2.

In accordance with an implementation of the hydraulic control system of the present invention, in addition to a power up requirements of a lift gate system, there are conditions that require a power down mode of operation of the lift gate system. An example of such condition would be cold weather environments where the hydraulic oil viscosity is increased as a result of the cold weather, and thereby has a direct effect on the oil flow rate in the hydraulic lines to and from the lift cylinders. Referring to FIG. 2, in the power down configuration, the directional valves 49 are preferably electrically activated in response to the up/down switch position on the lift gate system.

When activated in the power up mode, the directional valves 49 will connect hydraulic oil lines 1 and 2 to enable the corresponding pump 44R and 44L to pump oil into the lines leading to respective lift cylinder. The connection of the motor 42 to both pumps 44, along a single shaft, causes the pumps 44 to be synchronized with each other. This provides synchronization during power up operation of the lift.

When a power down condition is required, the directional valves are switched, and the lines 1 and 4 are connected to enable pumps 44 to increase pressure on the other end of the cylinder (i.e., the vent line) and essentially force the same to expand and push the connected platform downward. In this implementation relief valves 45 are added to line 4 and are set at a predetermined pressure (e.g., 500 psi). These relief valves 45 operate to prevent the downward pressure of the platform from lifting the rear end of the vehicle off the ground. Those of skill in the art will appreciate that in a power down operation, such relief valves become necessary.

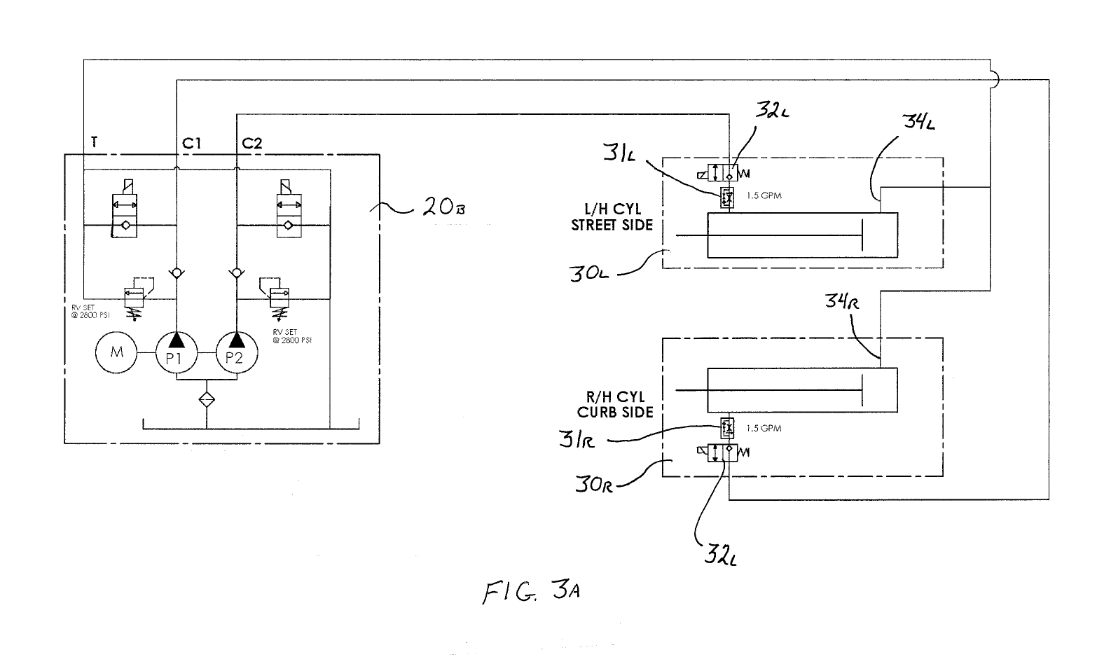

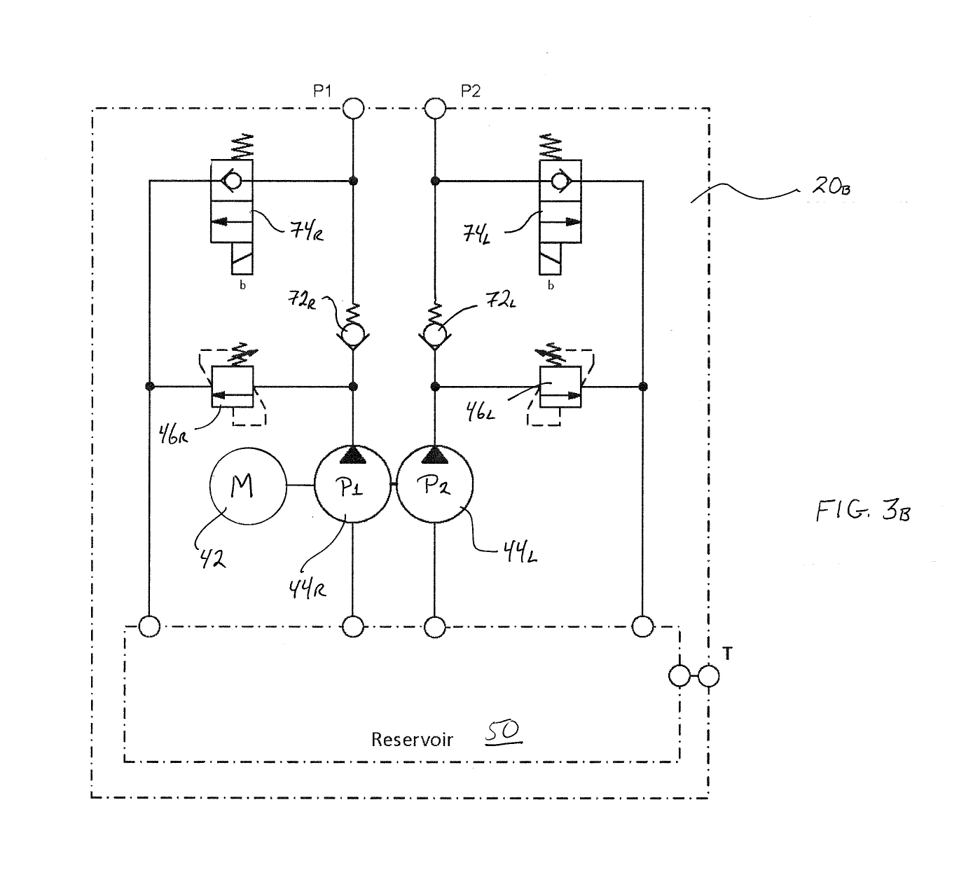

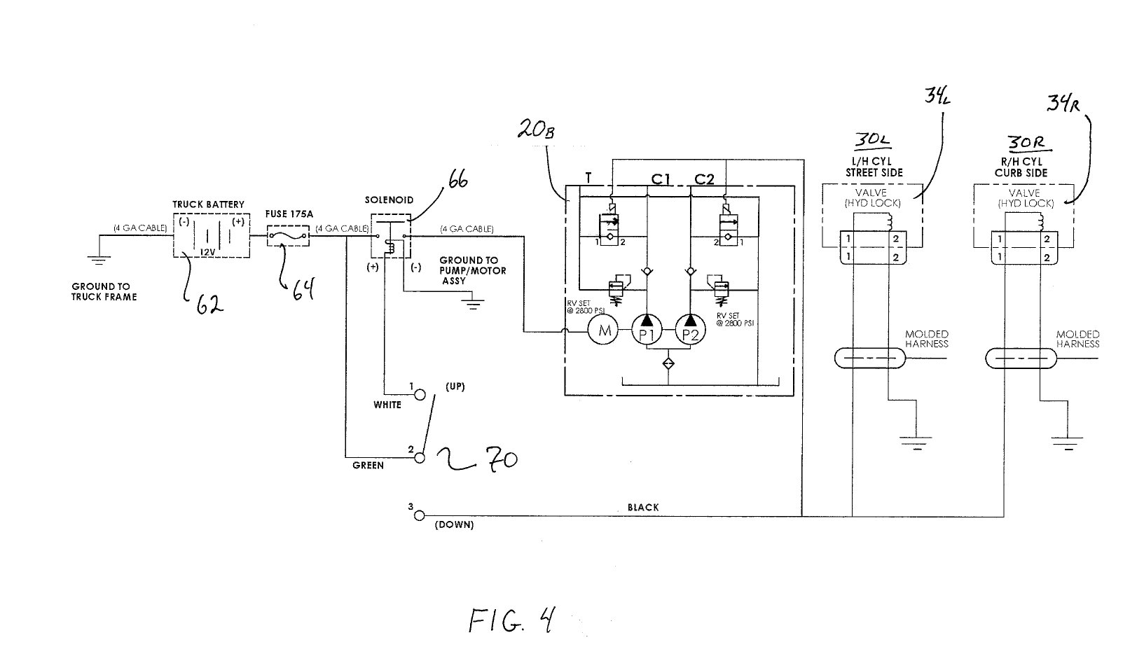

FIGS. 3a and 3b show the hydraulic pump control system 20c according to another embodiment of the present invention. FIG. 4 shows an electric schematic for the pump control system 20c. Directional flow valves 74 are configured and biased in the closed position until a power down operation is activated. During the power up scenario, check valves 72 allow oil to pass from the synchronized pumps 44 (powered by the single shaft of the motor 42) to the connected left and right cylinders, 30L and 30R. In a down operation scenario, the motor 42 is switched off, and an electric signal to the valves 74 causes the same to open and allow oil to pass from the cylinders through to reservoir tank 50. The flow of oil from each cylinder is carefully controlled and maintained equal by valves 74 and check valves 72.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A lift gate for vehicles comprising:
a first lift arm assembly having a first lift cylinder;
a second lift arm assembly having a second lift cylinder;
a platform connected to the first and second lift arm assemblies; and
a hydraulic control system connected to the first and second lift cylinders, the hydraulic control system comprising:
a motor;
a first hydraulic pump and a second hydraulic pump identical to the first hydraulic pump, each hydraulic pump being connected to a same single shaft of the motor; the first and second hydraulic pumps having an input connected to a reservoir tank, and an output;
a first directional valve having a first connection line connecting the first directional valve to the output of the first hydraulic pump, a second connection line connecting the first directional valve to a first lift cylinder, and a third connection line connecting the first directional valve to the reservoir tank;
a second directional valve having a first connection line connecting the second directional valve to the output of the second hydraulic pump, a second connecting line connecting the second directional valve to a second lift cylinder, and a third connection line connecting the first directional valve to the reservoir tank;
said first and second directional valves having an open and a closed operable position, the open position connecting the first hydraulic pump to the first lift cylinder and the second hydraulic pump to the second lift cylinder, and the closed position connecting the first and second lift cylinders to the reservoir tank.

2. The lift gate according to claim 1, wherein the hydraulically identical condition comprises an identical flow of oil being fed from the first and second pumps into the first and second lift cylinders via the second connection lines.

3. The lift gate according to claim 1, further comprising:
a fourth connection line connecting the first directional valve to a vent line of the first cylinder, said first directional valve connecting said fourth connection line to the reservoir tank during a power down operation; and
a fourth connection line connecting the second directional value to a vent line of the second cylinder, said second directional valve connecting said fourth connection line to the reservoir tank during a power down operation.

4. The lift gate according to claim 3, further comprising a first relief valve and a second relief valve each having an input and an output,
the input of the first relief valve having an input connected to the fourth connection line of the first directional valve and an output connected to the reservoir tank; and
the input of the second relief valve having an input connected to the fourth connection line of the second directional valve and an output connected to the reservoir tank.
